(19) United States
(12) Patent Application Publication
(10) Pub. No.: US 2014/0051824 A1
(43) Pub. Date: Feb. 20, 2014

(54) BIO-BASED PRE-REACTED PRODUCT OF A POLYOL AND A MONOMERIC OR POLYMERIC POLYCARBOXYLIC ACID

(71) Applicants: Kevin R. Anderson, Cedar Rapids, IA (US); Larry T. Banner, Ottumwa, IA (US); Shannon N. Shriver, Pella, IA (US); Shuang Zhou, Pella, IA (US)

(72) Inventors: Kevin R. Anderson, Cedar Rapids, IA (US); Larry T. Banner, Ottumwa, IA (US); Shannon N. Shriver, Pella, IA (US); Shuang Zhou, Pella, IA (US)

(73) Assignee: CARGILL, INCORPORATED, Wayzata, MN (US)

(21) Appl. No.: 14/110,068

(22) PCT Filed: Apr. 4, 2012
(86) PCT No.: PCT/US2012/032113

§ 371 Date: Oct. 4, 2013

Related U.S. Application Data
(60) Provisional application No. 61/472,999, filed on Apr. 7, 2011.

(51) Int. Cl. C08G 63/12

(52) U.S. Cl. CPC C08G 63/12
USPC 528/296

(57) ABSTRACT

An environmentally friendly, pre-reacted product of a polyol and monomeric or polymeric polycarboxylic acid or polyglycerol is provided. The pre-reacted product may include glycerol and esters of citric acid such a monoglyceryl citrate, diglyceryl citrate, and triglyceryl citrate as well as other citric acid-based esters. The pre-reacted product, when used in a binder, helps to speed the crosslinking reaction, induces faster water evaporation, decreases the viscosity of the binder, helps to reduce the amount of water needed for application of the binder, and decreases tackiness. The pre-reacted product may be used, for example, in the formation of insulation materials and non-woven chopped strand mats.

### CROSS REFERENCE TO RELATED APPLICATION

This application claims the benefit of the U.S. Provisional Patent Application, Ser. No. 61/472,999, filed Apr. 7, 2011, entitled BIO-BASED PRE-REACTED PRODUCT OF A POLYOL AND A MONOMERIC OR POLYMERIC POLYCARBOXYLIC ACID, which is hereby incorporated by reference in its entirety.

### TECHNICAL FIELD AND INDUSTRIAL APPLICABILITY OF THE INVENTION

The present invention relates generally to a pre-reacted product of an alcohol or polyol and a monomeric or polymeric polycarboxylic that is bio-based and is environmentally friendly. In particular, the pre-reacted product may comprise glycerol and esters of citric acid such a monoglyceryl citrate, diglyceryl citrate, and triglyceryl citrate.

### BACKGROUND OF THE INVENTION

Polymeric binder systems are used in many different products such as insulation materials and non-woven mats. Many of the components that make up these binders have problems associated with their use. For example formaldehyde-based resin suffer from the use of components that have undesirable formaldehyde emissions.

### SUMMARY OF THE INVENTION

One embodiment the present invention provides a pre-reacted product of a polyol and a monomeric or polymeric polycarboxylic acid. The pre-reacted product may be used, by itself or with a crosslinking agent and other components, such as polysaccharides, starches or cellulose, to form a polyester thermoset resin. The alcohol or polyol includes compounds such as aliphatic alcohols, glycerol, triethanolamine, ethylene glycol, polyethylene glycol, and pentaerythritol. The crosslinking agents may be any monomeric or polymeric polycarboxylic acid and/or their corresponding salts.

In other embodiments of the invention, the pre-reacted product is a composition that includes (i) about 5 wt % to about 25 wt % glycerol; (ii) about 10 wt % to about 70 wt % mixture of monoglyceryl citrate, diglyceryl citrate and triglyceryl citrate; and (iii) less than 5 wt % citric acid. In other embodiments, the composition includes about 12 wt % to about 50 wt % mixture of monoglyceryl citrate, diglyceryl citrate and triglyceryl citrate. In still other embodiments, the composition includes about 20 wt % to about 40 wt % mixture of monoglyceryl citrate, diglyceryl citrate and triglyceryl citrate. In some embodiments, the composition further includes about 25 wt % to about 80 wt % other higher molecular weight citric acid-derived esters. In at least one exemplary embodiment, the pre-reacted product has a weight average molecular weight of from about 1500 to about 5000 Daltons. In some embodiments, the composition may include a Group I metal cation or a citrate anion or both. In these embodiments, the molar ratio of the Group I metal cation to total citric acid, citrate anion, and citric acids esters is from about 1:99 to 25:75. In other embodiments, the molar ratio of the Group I metal cation to total citric acid, citrate anion, and citric acid esters is from about 3:99 to 10:99.

In still other embodiments of the invention, the pre-reacted product is a composition that includes (i) about 5 wt % to about 25 wt % glycerol based on the weight of the composition; (ii) about 10 wt % to about 70 wt % mixture of monoglyceryl citrate, diglyceryl citrate and triglyceryl citrate based on the weight of the composition; and (iii) a Group I metal cation or a citrate anion or both, wherein the molar ratio of the cation to total citric acid, citrate anion, and citric acids esters is from about 1:99 to 25:75. In other embodiments, the composition includes about 12 wt % to about 50 wt % mixture of monoglyceryl citrate, diglyceryl citrate and triglyceryl citrate. In still other embodiments, the composition includes about 20 wt % to about 40 wt % mixture of monoglyceryl citrate, diglyceryl citrate and triglyceryl citrate. In other embodiments, the molar ratio of the Group I metal cation to total citric acid, citrate anion, and citric acid esters is from about 3:99 to 10:99. In some embodiments, the composition further includes about 25 wt % to about 80 wt % other higher molecular weight citric acid-based esters based on the weight of the composition.

In yet other embodiment of the present invention, the pre-reacted product is made by a method comprising the steps of (i) heating a mixture of glycerol and citric acid in a molar ratio from about 1.5 moles glycerol:1 moles citric acid to less than 3 moles glycerol:1 mole citric acid at a temperature of about 115° C. to about 145° C.; and (ii) reacting the mixture from step (i) to obtain a pre-reacted product that includes (a) from about 5 wt % to about 25 wt % glycerol based on the weight of the pre-reacted product; (b) from about 10 wt % to about 70 wt % monoglyceryl citrate, diglyceryl citrate, and triglyceryl citrate based on the weight of the pre-reacted product and; (c) less than 5 wt % unreacted citric acid based on the weight of the pre-reacted product. In other embodiments, the composition includes about 12 wt % to about 50 wt % mixture of monoglyceryl citrate, diglyceryl citrate and triglyceryl citrate. In still other embodiments, the composition includes about 20 wt % to about 40 wt % mixture of monoglyceryl citrate, diglyceryl citrate and triglyceryl citrate. In some embodiments the pre-reacted product includes from about 25 wt % to about 80 wt % other higher molecular weight citric acid-derived esters. In some embodiments the pre-reacted product may include a Group I metal cation or a citrate anion or both.

Another embodiment of the invention includes a method of making a glycerol and citric acid pre-reacted product that includes the steps of (i) heating a mixture of glycerol and citric acid in a molar ratio from about 1.5 to less than about 3 moles glycerol:1 mole citric acid at a temperature of about 115° C. to about 145° C.; and (ii) reacting the mixture from step (i) to obtain a reaction product comprising (a) from about 5 wt % to about 25 wt % glycerol based on the weight of the pre-reacted product; b) from about 10 wt % to about 70 wt % a mixture of monoglyceryl citrate, diglyceryl citrate, and triglyceryl citrate; and (c) less than 5 wt % unreacted citric acid based on the weight of pre-reacted product. In other embodiments, the composition includes about 12 wt % to about 50 wt % mixture of monoglyceryl citrate, diglyceryl citrate and triglyceryl citrate. In still other embodiments, the composition includes about 20 wt % to about 40 wt % mixture of monoglyceryl citrate, diglyceryl citrate and triglyceryl citrate. In some embodiments, the method includes quenching the reaction with water or an aqueous sodium hydroxide solution. In still other embodiments, the method includes adding a hydroxide formed from a Group I metal cation or a citrate anion or both such as, for example, tri-sodium citrate, to the mixture before the reaction takes place. In yet other embodiments, a polyol selected from the group consisting of ethylene glycol, propylene glycol, polyethylene glycol, polypropylene glycol, polyglycerol, and mixtures thereof is added to the glycerol and citric acid before or after the reaction takes place.

Another embodiment of the invention includes a composition of a pre-reacted product and a coupling agent comprising:
A) from about 5 to about 60 wt % of a pre-reacted glycerol-citric acid product comprising:
   (i) about 5 wt % to about 25 wt % glycerol based on the weight of the pre-reacted composition;
   (ii) about 10 wt % to about 70 wt % mixture of monoglyceryl citrate, diglyceryl citrate and triglyceryl citrate based on the weight of the pre-reacted composition; and
   (iii) less than 5 wt % citric acid based on the weight of the pre-reacted composition, and
B) from about 40 to about 95 wt % citric acid based on the weight of A) and B).
   Yet another embodiment of the invention includes a composition of a pre-reacted product and a coupling agent comprising:
A) from about 5 to about 60 wt % of a pre-reacted glycerol-citric acid product comprising:
(i) about 5 wt % to about 25 wt % glycerol based on the weight of the pre-reacted composition;
(ii) about 10 wt % to about 70 wt % mixture of monoglyceryl citrate, diglyceryl citrate and triglyceryl citrate based on the weight of the pre-reacted composition; and
(iii) a Group I metal cation or a citrate anion or both, wherein the molar ratio of the Group 1 metal cation to total citric acid, citrate anion, and citric acid esters is from about 1:99 to 25:75; and
B) from about 40 to about 95 wt % citric acid based on the weight of A) and B).

In certain preferred aspects of the above embodiments, the polyol (e.g. glycerol) contains less than 500 ppm chloride ions. In certain embodiments, the polyol contains less than 300 ppm, less than 200 ppm, less than 100 ppm, less than 70 ppm, or less than 50 ppm chloride ions. Reduced chloride ions concentrations may minimize corrosion concerns in products that incorporate a composition using a pre-reacted product of the present invention. In other preferred aspects of the above embodiments, the polyol is technical grade or USP glycerol.

The use of the pre-reacted product of an alcohol or polyol with a monomeric or polymeric carboxylic acid in a binder system may help to speed the binder system crosslinking reaction, induce faster water evaporation, decrease the viscosity of the binder system, help to reduce the amount of water needed for application of the binder, and decreases tackiness.

Other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings.

FIG. 1 is a graphical illustration of the formation of a pre-reacted product where glycerol and citric acid react to provide monoglyceryl citrate, diglyceryl citrate, triglyceryl citrate and other higher molecular weight citric acid-derived esters.

FIG. 2 is a graphical illustration of the rheology data obtained from the inventive polyester bio-based binder containing a pre-reacted product of glycerol and citric acid where the glycerol and citric acid were pre-reacted for 1 h, 2 h, and 3 h, respectively, before adding the pre-reacted product to the binder composition. Additionally, a binder composition with added polyglycerol was included for comparison purposes.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity. Like numbers found throughout the figures denote like elements. It is to be noted that the phrase “binder”, “bio-based binder”, “binder composition”, and “binder formulation” may be used interchangeably herein.

The present invention relates to an environmentally friendly, pre-reacted product of an alcohol or polyol (e.g., glycerol) and a monomeric or polymeric polycarboxylic acid that contain bio-based components. The polyol includes, but is not restricted to, compounds such as glycerol, polyglycerol, triethanolamine, sorbitol, ethylene glycol, propylene glycol, polyethylene glycol, pentaerythritol, and other compounds having a number average hydroxyl functionality of greater than one (fn>1.0), preferably at least 2. The pre-reacted product of a polyol and a monomeric or polymeric polycarboxylic acid may be present, for example, in a binder composition in an amount from about 5% to about 60% by weight, from about 10% to about 40% by weight, or from about 10% to about 30% by weight.

The pre-reacted product may be a composition that includes (i) about 5 wt % to about 25 wt % glycerol based on the weight of the composition; (ii) about 20 wt % to about 70 wt % mixture of monoglyceryl citrate, diglyceryl citrate and triglyceryl citrate based on the weight of the composition; and (iii) less than 5 wt % citric acid based on the weight of the composition. In some embodiments, the pre-reacted product has a weight average molecular weight of from about 1500 to about 5000 Daltons. The pre-reacted product may have a viscosity of less than about 250 cP at 130° C., or less than about 200 cP at 130° C. In some embodiments, the composition may include a Group I metal cation or a citrate anion, or both. In these embodiments, the molar ratio of the Group I metal cation to total citric acid, citrate anion, and glycerol-citric acid pre-reacted product is from about 1:99 to 25:75. In other embodiments, the molar ratio of the Group I metal cation to total citric acid, citrate anion, and glycerol-citric acid adduct is from about 3:99 to 10:99. In some embodiments, the composition may include about 25 wt % to about 80% citric acid-based esters.

In other embodiments, the pre-reacted product may be a composition that includes (i) about 5 wt % to about 25 wt % glycerol based on the weight of the composition; (ii) about 20 wt % to about 70 wt % mixture of monoglyceryl citrate, diglyceryl citrate and triglyceryl citrate based on the weight of the composition; and (iii) a Group I metal cation and a citrate anion, wherein the molar ratio of the cation to total citric acid, citrate anion, monoglyceryl citrate, diglyceryl citrate and triglyceryl citrate is from about 1:99 to 25:75. In still other embodiments, wherein the molar ratio of the cation to total citric acid, citrate anion, monoglyceryl citrate, diglyceryl citrate and triglyceryl citrate is from about 3:99 to 10:99.

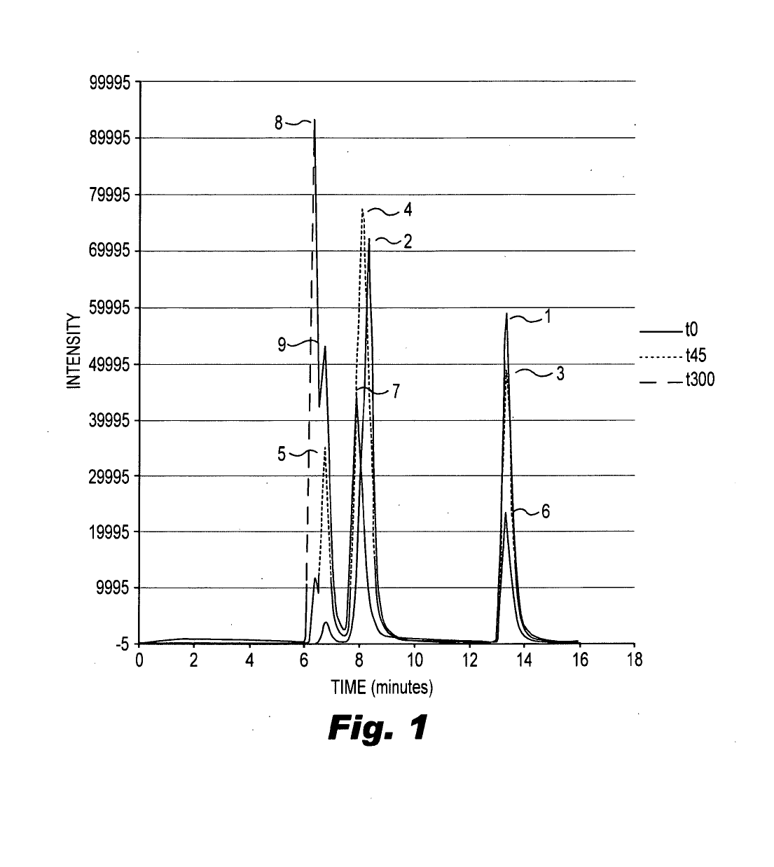

The pre-reacted product is made by heating a mixture of glycerol and citric acid in a molar ratio from about 1.5 moles glycerol:1 moles citric acid to less than 3 moles glycerol:1 moles citric acid at a temperature of about 115° C. to about 145° C. The mixture of glycerol and citric acid may be heated under vacuum, at ambient pressures, or under pressure in a sealed reaction vessel. FIG. 1 provides a graphical illustration of the formation of a pre-reacted product made from glycerol and citric acid. Glycerol is heated to about 80° C. and citric acid is added to the heated glycerol. The amount of glycerol and citric acid in the mixture at the time the mixture reaches the reaction time are illustrated by the labeled peaks 1 and 2 in FIG. 1 (t0, after adding citric acid to the glycerol at 80° C.). After the temperature of the glycerol and citric acid mixture reaches about 120-140° C., the glycerol and citric acid react to form a mixture of monoglyceryl citrate, diglyceryl citrate, triglyceryl citrate and other citric acid-based esters that have a molecular weight greater than the mono-, di-, and triglyceryl citrates. These reactants and reaction products are illustrated by the labeled peaks 3, 4 and 5 in FIG. 1 after reacting for about 45 minutes (t45). As the reaction proceeds, essentially all of the citric acid reacts, however the pre-reacted product still includes about 5-25 wt % unreacted glycerol as illustrated by labeled peak 6 in FIG. 1 after reacting for 5 hours (t300). The reaction or disappearance of citric acid in the mixture is illustrated by the disappearance or absence of the labeled peak 2. The labeled peaks 7, 8 and 9 also illustrate the formation of the mono-, di- and triglyceryl esters and citric acid-based esters having molecular weights greater the mono-, di- and triglyceryl ester. Suitable reaction times are from about 1.5 hours to 24 hours. In some embodiments, the reaction proceeds until there is less than 25% unreacted glycerol. In other embodiments, the reaction proceeds until there is less than 15% unreacted glycerol. In still other embodiments, a Metal I cation, a citrate anion, or both are included in the reaction mixture. The pH of the pre-reacted product can be adjusted to be in a range of about 0.5 to about 6, preferably adjusted in a range of about 0.5 to 4, or preferably adjusted in a range of about 1.9 to 2.6.

The various components of the composition illustrated by FIG. 1 were readily determined by diluting an aliquot of the mixture of glycerol and citric acid with 100 parts by weight of a 0.01 N sulfuric acid solution and then analyzing the diluted aliquot by HPLC using a BioRad 87H column at a temperature of 60° C. at a flow rate of 0.6 mL/min using a refractive index detector.

If desired, the reaction can be quenched with either water or an aqueous solution of sodium hydroxide after the reaction has been going for a pre-determined period of time. When the reaction is quenched with water or with a solution of sodium hydroxide, typically having a temperature of less than 100° C., generally less than 15 wt % of the solution based on the weight of the reaction mixture is added. In other embodiments, less than 10 wt %, or less than 5 wt %, of the solution based on the weight of the reaction mixture is added. Some embodiments of the quenched reaction product have about 5 wt % water and from about 3 wt % to about 20 wt % glycerol. The viscosities of the diluted reaction mixtures, when measured at 25° C., may range from about 35,000 cP for 5 w % added water to about 1,600 cP for 15 wt % added water.

In some embodiments, a polyol selected from the group consisting of ethylene glycol, propylene glycol, polyethylene glycol, polypropylene glycol, polyglycerol, and mixtures thereof is added to the glycerol and citric acid before or after the reaction takes place. In these embodiments the amount of added polyol is generally from about 1 wt % to about 10 wt % based on the weight of the glycerol and added polyol.

The reaction conditions and processes set out above provide a pre-reacted product that includes (a) from about 5 wt % to about 25 wt % glycerol; (b) from about 10 wt % to about 70 wt % monoglyceryl citrate, diglyceryl citrate, and triglyceryl citrate; (c) and less than 5 wt % unreacted citric acid. The pre-reacted product may include a Metal I cation, a citrate anion, or both as well as higher molecule weight citric acid-based esters. A suitable Metal I cation, for example, is sodium. A suitable citrate anion, for example, is tri-sodium citrate.

In other embodiments the pre-reacted product may be combined with a crosslinking agent. Suitable crosslinking agents include polycarboxylic acids such as, for example, citric acid. In exemplary embodiments, a suitable crosslinking agent has a number average molecular weight greater than 90, from about 90 to about 10,000, or from about 190 to about 4,000. In some exemplary embodiments, the crosslinking agent has a number average molecular weight less than about 1000. Non-limiting examples of suitable crosslinking agents include polycarboxylic acids (and salts thereof), anhydrides, monomeric and polymeric polycarboxylic acid with anhydride (i.e., mixed anhydrides), citric acid (and salts thereof, such as ammonium citrate), 1,2,3,4-butane tetracarboxylic acid, adipic acid (and salts thereof), polyacrylic acid (and salts thereof), and polyacrylic acid based resins such as QXRP 1734 and Acumer 9932, both commercially available from The Dow Chemical Company. The crosslinking agent may be present in the pre-reacted product composition in an amount up to about 40 wt % to about 95 wt %.

One embodiment of a pre-reacted product and a crosslinking composition comprises:
A) from about 5 to about 60 wt % of a pre-reacted glycerol-citric acid product comprising:
(i) about 5 wt % to about 25 wt % glycerol based on the weight of the pre-reacted product;
(ii) about 10 wt % to about 70 wt % mixture of monoglyceryl citrate, diglyceryl citrate and triglyceryl citrate based on the weight of the pre-reacted product; and
(iii) less than 5 wt % citric acid based on the weight of the pre-reacted product, and
B) from about 40 to about 95 wt % citric acid based on the weight of A) and B).
   Another embodiment of a composition of a pre-reacted product and a coupling agent comprises:
A) from about 5 to about 60 wt % of a pre-reacted glycerol-citric acid product comprising:
(i) about 5 wt % to about 25 wt % glycerol based on the weight of the pre-reacted product;
(ii) about 10 wt % to about 70 wt % mixture of monoglyceryl citrate, diglyceryl citrate and triglyceryl citrate based on the weight of the pre-reacted product; and
(iii) a Group I metal cation or a citrate anion or both, wherein the molar ratio of the Group I metal cation to total citric acid, citrate anion, and citric acid esters is from about 1:99 to 25:75; and
B) from about 40 to about 95 wt % citric acid based on the weight of A) and B).

### End Uses for the Pre-Reacted Product

The pre-reacted product of the present invention may be useful in a variety of applications including composite reinforcements, such as chopped strands, thermoplastics, thermosets, and roofing applications. The pre-reacted product may be used in the formation of insulation materials and non-woven chopped strand mats. In addition, the pre-reacted product may be useful in forming particleboard, plywood, and/or hardboards.

Insulation.

The pre-reacted product may be used in a binder composition to form an insulation product. Fibrous insulation products are generally formed of matted inorganic fibers bonded together by a cured thermoset polymeric material. Examples of suitable inorganic fibers include glass fibers, wool glass fibers, and ceramic fibers.

Non-Woven Mats.

The pre-reacted product may be used in a binder composition may be used to form a non-woven chopped strand mat. The non-woven mat can be used in roofing, flooring, ceiling, wall applications, as filters, in ground based vehicles, and in aircraft.

Polyester Binders.

The pre-reacted product may be used in a polyester bio-based binder composition formed of a carbohydrate (e.g., maltodextrin), a crosslinking agent (e.g., polyacrylic acid or citric acid), and a pre-reacted product that is the reaction product of an alcohol or polyol with a monomeric or polymeric polycarboxylic acid that is disclosed in US Appln [Attorney Docket No. N00121 (CAR0110/P1)] titled “Bio-based Binders Including Carbohydrates and a Pre-reacted Product of an Alcohol or Polyol and a Monomeric or Polymeric Polycarboxylic Acid” filed Apr. 7, 2011 and incorporated herein by reference. The range of components used in this exemplary binder is set forth in Table 1.

TABLE 1

| | % By Weight |
|---|---|
| Component | of Total Solids |
| Carbohydrate | 30-95 |
| Crosslinking Agent | 1-40 |
| Pre-reacted product of an alcohol or | 5-50 |
| polyol and a monomeric or polymeric | |
| polycarboxylic acid | |

Having generally described this invention, a further understanding can be obtained by reference to certain specific examples illustrated below which are provided for purposes of illustration only and are not intended to be all inclusive or limiting unless otherwise specified.

### EXAMPLES

### Example 1

Pre-Reacted Product of Glycerol and Citric Acid

General procedure. Glycerol (USP grade) is added to a reaction vessel fitted with a temperature probe and agitator. The amount of glycerol is selected to provide a molar ratio of glycerol to citric acid of about 1.5-3:1. The glycerol is heated to a reaction temperature of about 115° C. to about 145° C. As the glycerol reaches a temperature of about 80° C., citric acid is added to the reaction vessel in small portions. The reaction is allowed to proceed for about 1.5 hours to about 24 hours. The reaction may be quenched with water or an aqueous sodium hydroxide solution if desired.

Using the general conditions above, 13 samples were prepared. The properties of these samples are provided in Table 2.

TABLE 2

| | Glycerol:total | | | | |
|---|---|---|---|---|---|
| | citric/citrate | Temp | | Relative % Conversion | Glycerol remaining |
| Exp # | (molar ratio) | (° C.) | Other conditions | (reduction of glycerol) | (g gly/g product) |
| 1007-006 | 2:1 | 130 | | 75% @ 8 hrs | 0.13 |
| 1007-011 | 2:1 | 140 | | 75% @ 3 hrs | 0.13 |
| 1008-002 | 2:1 | 120 | | 70% @ 6 hrs | 0.15 |
| 1008-004 | 2:1 | 120 | | 72% @ 5 hrs | 0.14 |
| 1008-005 | 3:1 | 130 | | 69% @ 23.5 hrs | 0.18 |
| 1008-006 | 3:1 | 140 | | 71% @ 9.75 hrs | 0.17 |
| 1008-012 | 2.5:1 | 120 | | 76% @ 22.5 hrs | 0.13 |
| 1009-002 | 2:1 | 130 | | 74% @ 3 hrs | 0.12 |
| 1009-003 | 3:2 | 130 | | 82% @ 1.5 hrs | 0.07 |
| 1009-007 | 2:1 | 130 | 2:1 citric:trisodium citrate | 49% @ 4.5 hrs | 0.23 |
| 1009-009 | 2:1 | 130 | 5:1 citric:trisodium citrate | 64% @ 3.5 hrs, 68% @ 19 hrs | 0.17 (3.5 hours), 0.15 (19 hours) |
| 1009-011 | 2:1 | 130 | 11:1 citric:trisodium citrate | 72% @ 3 hrs, 75% @ 23.5 hrs | 0.13 (3 hours), 0.12 (23.5 hours) |
| 1009-012 | 3:2 | 130 | 5:1 citric:trisodium citrate | 73% @ 2.5 hrs, 77% @ 18.5 hrs | 0.11 (2.5 hours), 0.09 (18.5 hours) |

| | | | | | Relative Composition (Area %) | | |
|---|---|---|---|---|---|---|---|
| | | Mw Information* | | | mono/di/tri | Higher | |
| Exp # | pH | Mn | Mw | PD | esters | Mw esters | Glycerol |
| 1007-006 | 0.9 | 2684 | 2136 | 1.69 | 23 | 65 | 12 |
| 1007-011 | 1-1.5 | | | | 22 | 66 | 12 |
| 1008-002 | — | | | | 28 | 58 | 14 |
| 1008-004 | 1.2-1.4 | | | | 28 | 59 | 13 |
| 1008-005 | — | 1910 | 2126 | 1.51 | 17 | 64 | 16 |
| 1008-006 | 1.8-2.2 | | | | 14 | 70 | 16 |
| 1008-012 | 1.5 | | | | 18 | 70 | 12 |
| 1009-002 | 0.8 | | | | 34 | 54 | 12 |
| 1009-003 | — | 3613 | 3259 | 1.46 | 28 | 66 | 6 |
| 1009-007 | — | | | | 47 | 33 | 20 |
| 1009-009 | 4.2 | | | | 33 | 52 | 15 |
| 1009-011 | 4.3 | | | | 24 | 65 | 11 |
| 1009-012 | 3.6 | 3113 | 4057 | 1.3 | 32 | 59 | 9 |

*Mw were determined by using the Dionex P680 Pump and Shimadzu RID-6A and Polylab SEC offline software under the following conditions:
Temperature: (30° C.)
Eluent and Solvent: 0.1M NaNo3 in DI water
Sample Conc: 0.40%
Injection Volume: 20 μl
Flow rate: 0.5 ml/minute
Columns: Guard column: 08033-TSKgel Guard PWxl
TOSOH Bioscience SEC columns
1) TSK-GEL G4000pwxl
2) G3000pwxl and
3) G2500pwxl
Standards: Polymer Laboraties PEG/PEO Easivial (Mw range 1258000-194)

### Example 2

Pre-Reacted Product in a Binder

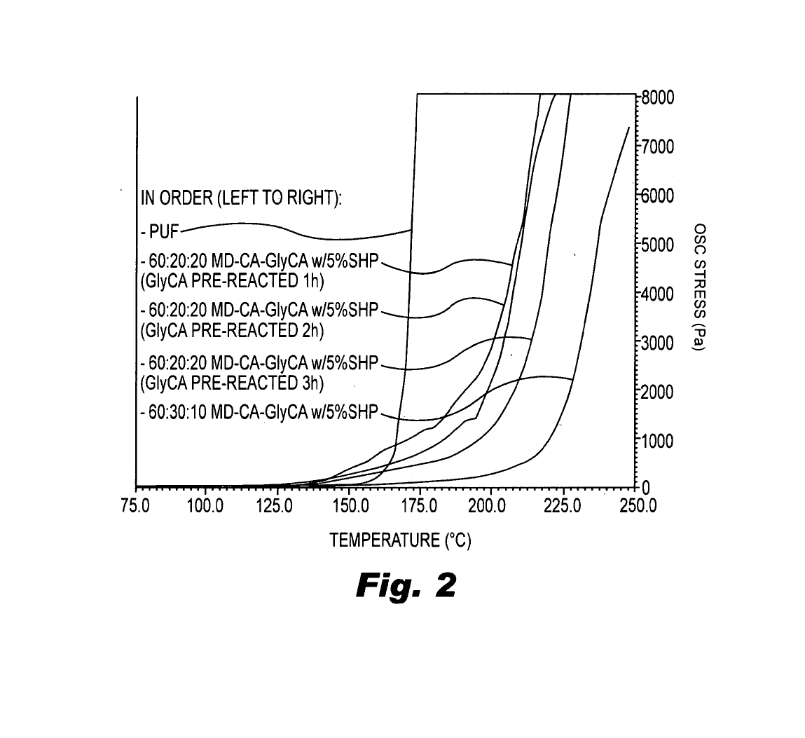

A pre-reacted product of glycerol and citric acid was made by heating 10 kg of glycerol combined with 10.4 kg of anhydrous citric acid in a chemical reactor at 130° C. for 1, 2, or 3 hours under ambient conditions. For most of the binder compositions, the glycerol/citric acid product was dissolved in water to a 50% concentration prior to be used. FIG. 2 illustrates the rheology data obtained from the polyester bio-based binders containing a pre-reacted product of glycerol and citric acid where the glycerol and citric acid were pre-reacted for 1 h, 2 h, and 3 h, respectively, before adding the pre-reacted product to the binder composition. Additionally, a binder composition with added polyglycerol was included in FIG. 2 for comparison purposes.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A pre-reacted product composition comprising:
(i) about 5 wt % to about 25 wt % glycerol based on the weight of the composition;
(ii) about 10 wt % to about 70 wt % mixture of monoglyceryl citrate, diglyceryl citrate and triglyceryl citrate based on the weight of the composition; and
(iii) less than 5 wt % citric acid based on the weight of the composition,
wherein the pre-reacted composition has a weight average molecular weight of from about 1500 to about 5000 Daltons.

2. The composition of claim 1, further comprising a Group I metal cation or a citrate anion or both, wherein the molar ratio of the Group I metal cation to total citric acid, citrate anion, and citric acid esters is from about 1:99 to 25:75.

3. (canceled)

4. The composition of claim 1, further comprising a citrate anion, wherein the molar ratio of the citrate anion to total citric acid, citrate anion, and citric acid esters is from about 1:99 to about 25:75.

5. (canceled)

6. The composition of claim 1, wherein the composition has a pH of from about 0.5 to about 6.

7. The composition of claim 2, wherein the citrate anion is obtained from tri-sodium citrate.

8. The composition of claim 2, wherein the citrate anion is obtained by reacting citric acid with a Group I metal hydroxide compound.

9. The composition of claim 8, wherein the Group I metal hydroxide comprises sodium hydroxide.

10. (canceled)

11. (canceled)

12. (canceled)

13. (canceled)

14. The composition of claim 1, wherein the viscosity of the composition is less than 250 cP at 130° C.

15. The composition of claim 1, wherein the viscosity of the composition is less than 200 cP at 130° C.

16. The composition of claim 1, further comprising about 25 wt % to about 80 wt % other citric acid-derived esters.

17. The composition of claim 1, further comprising a crosslinking agent.

18. The composition of claim 17 wherein the crosslinking agent is a polycarboxylic acid.

19. (canceled)

20. A pre-reacted product composition comprising:
A) about 5 wt % to about 25 wt % glycerol based on the weight of the composition;
B) about 10 wt % to about 70 wt % mixture of monoglyceryl citrate, diglyceryl citrate and triglyceryl citrate based on the weight of the composition; and
C) a Group I metal cation or a citrate anion or both, wherein the molar ratio of the Group I metal cation to total citric acid, citrate anion, and citric acid esters is from about 1:99 to 25:75.

21. (canceled)

22. The composition of claim 20, further comprising a citrate anion, wherein the molar ratio of the citrate anion to total citric acid, citrate anion, and citric acid esters is from 1:99 to 25:75.

23. The composition of claim 22, wherein the molar ratio of the citrate anion to total citric acid, citrate anion, and citric acid esters is from 3:99 to 10:99.

24. The composition of claim 20, wherein the composition has a pH of from about 0.5 to about 6.

25. The composition of claim 20, wherein the viscosity of the composition is less than 250 cP at 130° C.

26. (canceled)

27. The composition of claim 20, further comprising about 25 wt % to about 80 wt % other citric acid-derived esters.

28. The composition of claim 20, further comprising a crosslinking agent.

29-101. (canceled)
